(19) United States
(12) Patent Application Publication
(10) Pub. No.: US 2008/0245783 A1
(43) Pub. Date: Oct. 9, 2008

(54) FOOD HEATING WARMER

(75) Inventors: SHUKI AOYAMA, Ibaraki (JP); Masanobu Yanagihara, Ibaraki (JP); Mitsuhiro Ryuzaki, Fuji (JP); Yasushi Souda, Fuji (JP)

Correspondence Address: DLA PIPER US LLP, P. O. BOX 9271, RESTON, VA, 20195, US

(73) Assignees: TOSHIBA CONSUMER MARKETING CORPORATION, Chiyoda-Ku (JP); TOSHIBA HA PRODUCTS CO., LTD., Ibaraki (JP); NISHIYAMA INDUSTRY CO., LTD., Fuji (JP)

(21) Appl. No.: 12/052,979

(22) Filed: Mar. 21, 2008

(30) Foreign Application Priority Data
Apr. 3, 2007 (JP) 2007-97688
Jul. 2, 2007 (JP) 2007-173985

(51) Int. Cl. H05B 3/68

(52) U.S. Cl. 219/448.12; 219/214

(57) ABSTRACT

A food heating warmer includes a placing section divided into a plurality of divided sub-sections in a warming compartment so that food is placed on the placing section, a plurality of constant temperature heating units located so as to correspond to the divided sub-sections of the placing section, each unit including a heater for heating the divided sub-section, a divided section temperature sensor detecting a temperature in each divided sub-section, and a switching element turning the heater on and off according to the temperature detected by the divided sub-section temperature sensor, a failure detecting unit which detects failures of the constant temperature heating units provided for the respective divided sub-sections of the placing section, and a notifying unit which specifies and notifies the constant temperature. heating unit for which failure has been detected by the failure detecting unit.

### CROSS-REFERENCE TO RELATED APPLICATIONS

This application is based upon and claims the benefit of priority from the prior Japanese Patent Application Nos. 2007-97688, filed on Apr. 3 and 2007 and 2007-173985, filed on Jul. 2, 2007, the entire contents of both of which are incorporated herein by reference.

### BACKGROUND OF THE INVENTION

1. Field of the invention

The present invention relates to a food heating warmer including a warming compartment in which food placing members such as shelf plates are provided and heated by a heater so that food placed on the placing member is heated and kept warm.

2. Description of the related art

Food heating warmers are usually constructed into showcases and installed in convenience stores and the like. JP-A-H07-231835 discloses a showcase having a cold storage compartment and a warm storage compartment. Hot plates serving as a food placing member are provided in a plurality of stages in the warm storage compartment. Heat is applied to the hot plates so that food placed on the hot plates is heated and kept warm.

Furthermore, JP-A-2004-173797 discloses a food heating warmer constructed into a showcase in which Chinese “mantou” or pounded rice cake or the like is placed for selling or vendition purposes. Air heated by a bottom heater is convected so that an atmosphere in the warm storage compartment is heated. Furthermore, heat generated by a side heater is transferred to a plurality of food shelves by heat transfer thereby to heat food. The food heating warmer is further provided with a steam generator which generates steam in order that the Chinese mantou may be steamed.

Heaters are provided for a plurality of hot plates respectively in a food heating warmer of the type that the hot plates are heated by the respective heaters so that food is heater and kept warm. Accordingly, when one of the heaters has been disconnected, only the hot plate in relation to the disconnected heater loses a heating function. However, the other top plates still serve as heat sources. Therefore, it is difficult for users such as a shop clerk to find out failure of a top plate.

Furthermore, the heater for the top plate is usually controlled by a thermostat which detects a temperature of the hot plate to turn on or off the heater. However, when a failure such as contact welding occurs in the thermostat, the heater is kept energized such that the temperature of the hot plate rises.

The user finds a failure of the hot plate when the temperature in the compartment is rendered lower or higher than usual due to the failure of the hot plate. However, even when having found the failure of the hot plate, the user has a difficulty in realizing which one of the hot plates has failed. When touching the hot plates, the user can realize that the hot plate whose temperature is lower or higher has failed. However, the user needs to touch the hot plates in normal operation or the hot plates whose temperatures are higher due to contact welding of the thermostats.

The food heating warmer disclosed by the above-referenced document, JP-A-2004-173797, is provided with a temperature sensor detecting a temperature in the warm storage compartment and a humidity sensor detecting a humidity in the warm storage compartment. The control device detects failure of these temperature and humidity sensors. When the temperature and humidity sensors have not failed, the control device controls heating, warm keeping and the like. When either one or both of the temperature and humidity sensors have failed, the control device stops operation of the heating warmer (see paragraphs [0159] to [0161]). When the control manner disclosed in JP-A-2004-173797 is applied to a food heating warmer provided with a plurality of hot plates, the food heating warmer can detect drop or rise of the temperature in the warm storage compartment. However, the food heating warmer cannot determine whether the temperature drop in the warm storage compartment has resulted from disconnection of the heater. Additionally, even when disconnection of the heater is detected, the hot plate corresponding to the disconnected heater cannot be detected.

### SUMMARY OF THE INVENTION

Therefore, an object of the present invention is to provide a food heating warmer which can specify a failed constant temperature heating section when the constant temperature heating section which heats placing sections of food and keeps the placing sections warm.

The present invention provides a food heating warmer comprising a warming compartment, a placing section divided into a plurality of sub-sections in the warming compartment so that food is placed on the placing section, a plurality of constant temperature heating units which are provided so as to correspond to the sub-sections of the placing section, each unit including a heater for heating the sub-section, a sub-section temperature sensor detecting a temperature in each sub-section, and a switching element turning the heater on and off according to the temperature detected by the sub-section temperature sensor, a failure detecting unit which detects failures of the constant temperature heating units provided for the respective sub-sections of the placing section, and a notifying unit which specifies and notifies the constant temperature heating unit for which failure has been detected by the failure detecting unit.

In the above-described construction, the failure detecting unit detects the failed one of the constant temperature heating units. The notifying unit specifies and notifies the failed constant temperature heating unit. Consequently, since the failed constant temperature heating unit is specified, the user can cope with the failure promptly.

### BRIEF DESCRIPTION OF THE DRAWINGS.

Other objects, features and advantages of the present invention will become clear upon reviewing the following description of the embodiment with reference to the accompanying drawings, in which:

FIGS. 1A and 1B are front views of an operation panel employed in a food heating warmer in accordance with a first embodiment of the present invention;

FIG. 2 is a perspective view of the food heating warmer as viewed from the front side;

FIG. 3 is a perspective view of the food heating warmer as viewed from the rear side;

FIG. 4 is a sectional view taken along line 4-4 in FIG. 3;

FIG. 5 is a sectional view taken along line 5-5 in FIG. 3;

FIG. 6 is a block diagram showing an electrical arrangement of the food heating warmer;

FIG. 7 is a circuit diagram showing an arrangement of a sensor circuit and a heater circuit;

FIG. 8 is a flowchart showing contents of temperature control;

FIG. 9 is a flowchart showing contents of temperature control of placing sections;

FIG. 10 is a flowchart showing contents of interior temperature control;

FIG. 11 is a flowchart showing contents of door control;

FIG. 12A shows three-stage set temperatures for each sub-section of the placing section;

FIG. 12B shows upper and lower limit temperatures of the placing section and a warming compartment; and

FIG. 13 shows the relationship between code designation and failure contents.

### DETAILED DESCRIPTION OF THE INVENTION

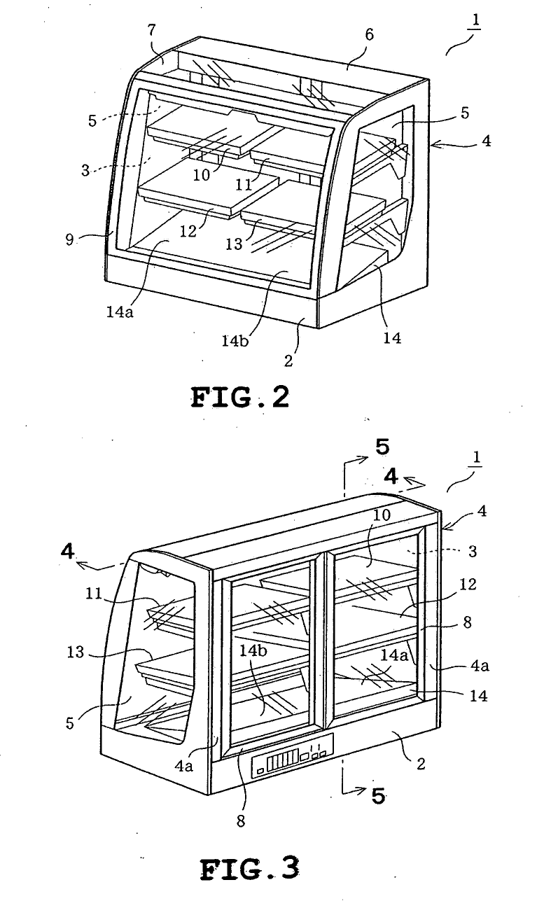

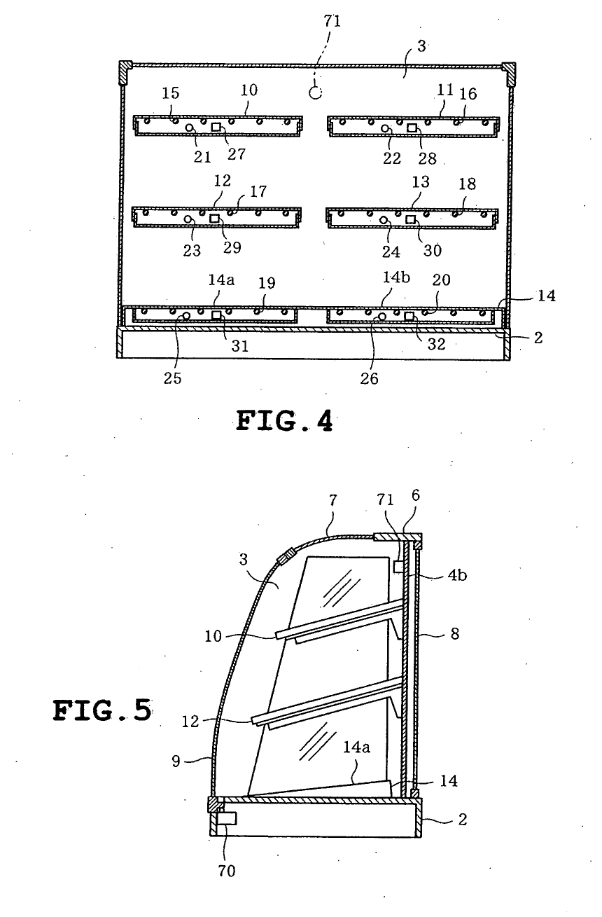

A first embodiment of the invention will be described with reference to the accompanying drawings. A food heating warmer 1 of the first embodiment is for industrial use and is installed in convenience stores or the like. Referring to FIGS. 2 to 5, the food heating warmer 1 comprises a base 2 and a warming compartment 3 serving as a showcase. The warming compartment 3 comprises a frame 4, two side glass plates 5 fixed to right and left sides of the frame 4 respectively, a ceiling plate 6 which is fixed to the frame 4 so as to compose a rear half of the ceiling, a ceiling glass plate. 7 which is fixed to the frame 4 so as to compose a front half of the ceiling, two sliding doors 8 opening and closing the rear of the frame 4, and a sliding door 9 opening and closing the inclined front of the frame 4. The sliding doors 8 are mounted so as to be slidable between right and left rear support pillars 4a. The sliding door 9 is mounted so as to be slidable vertically relative to the frame 4 by a sliding mechanism which is not shown.

Each sliding door 8 includes a sash and a glass plate fitted with an inside of the sash and opens and closes the rear of the warming compartment 3. Furthermore, the sliding door 9 includes a sash and a slightly curved glass plate fitted with an inside of the front of the sash and opens and closes the front of the warming compartment 3. Accordingly, an interior of the warming compartment is viewable through the side glass plates 5, ceiling glass plate 7 and sliding doors 8 and 9. The sliding doors 8 are opened and closed by the user or shop clerk when articles enclosed in the warming compartment 3 are sold. The sliding door 9 is opened and closed by the user when the interior of the warming compartment 3 is cleaned or in other occasions.

A plurality of metal shelves 10 to 13 are mounted in the warming compartment 3 so as to be arranged in a plurality of stages (two stages in the embodiment). The shelves 10 to 13 serve as a placing section together with a metal bottom plate 14 constituting the bottom of the warming compartment 3. The placing section comprised of the shelves 10 to 13 and the bottom plate 14 is divided into a plurality of sub-sections. In the embodiment, the shelves 10 to 13 serve as respective subdivisions and the bottom plate 14 is divided at the center thereof into two sub-sections or left and right bottom plates 14a and 14b.

Heaters and temperature sensors are provided in the respective subdivisions of the placing section (shelves 10 to 13 and left and right bottom plates 14a and 14b). In the embodiment, for example, cord-like heaters. 15 to 20 are provided on the undersides of the shelves 10 to 13 and left and right bottom plates 14a and 14b in a meandering shape so as to heat the sub-sections, respectively. Accordingly, the shelves 10 to 13 and the bottom plate 14 serve as hot plates for heating food placed on the sub-sections respectively. Furthermore, placing section temperature sensors 21 to 26 are also provided on the undersides of the shelves 10 to 13 and left and right bottom plates 14a and 14b respectively. The placing section temperature sensors 21 to 26 serve as sub-section temperature sensors detecting temperatures of the sub-sections respectively. Additionally, thermal fuses 27 to 32 are also provided on the shelves 10 to 13 and left and right bottom plates 14a and 14b respectively. The thermal fuses 27 to 32 are adapted to melt down when the temperatures of the sub-sections exceed a predetermined high temperature.

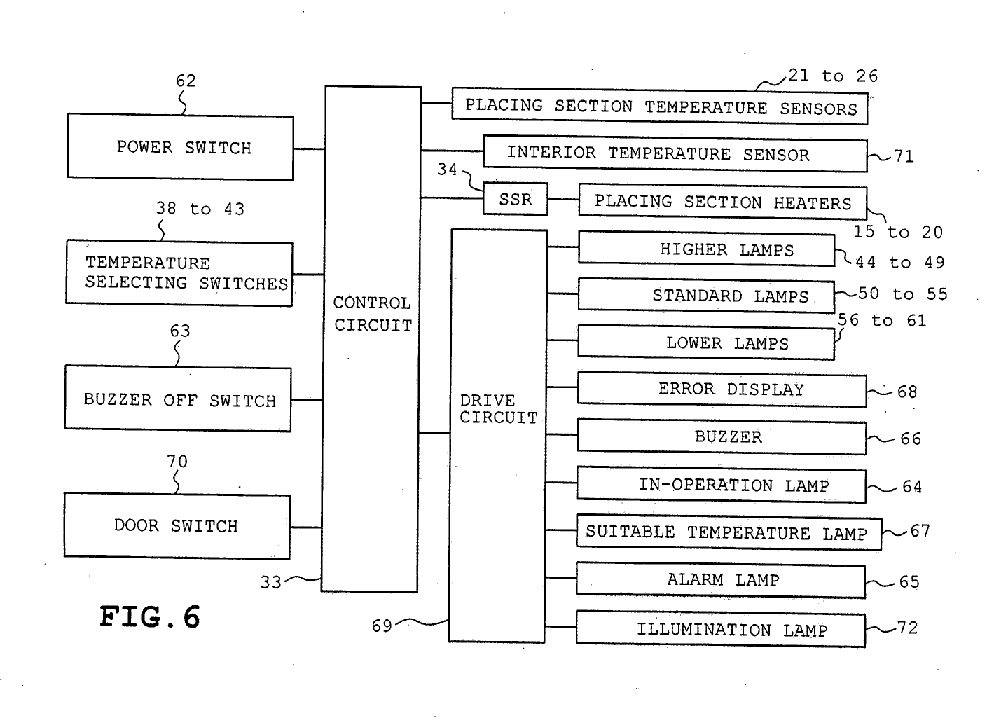

The placing section temperature sensors 21 to 26 are connected to a control circuit 33 as shown in FIG. 6. The heaters 15 to 20 are connected via a solid state relay (SSR) 34 serving as a switching element to the control circuit 33. The control circuit 33 detects temperatures of the shelves 10 to 13 and left and right bottom plates 14a and 14b, based on detection signals from the placing section temperature sensors 21 to 26, thereby controlling the heaters 15 to 20 according to the detection temperatures via SSR 34 so that the heaters 15 to 20 are turned on and off, respectively.

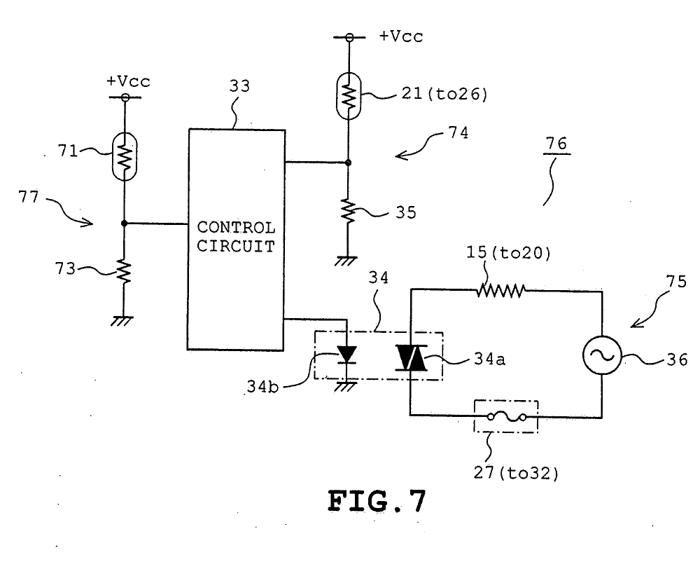

More specifically, each of the placing section temperature sensors 21 to 26 comprises a thermistor changing a resistance value thereof according to a temperature, for example. One terminals of the placing section temperature sensors 21 to 26 are connected to a positive power supply +Vcc, whereas the other terminals of the sensors 21 to 26 are grounded via a resistance 35, as shown in FIG. 7. A common node of the placing section temperature sensors 21 to 26 and the resistance 35 is connected to the control circuit 33. As a result, the control circuit 33 enters a divided voltage at the common node as a detection signal (voltage) of each of the placing section temperature sensors 21 to 26.

On the other hand, as shown in FIG. 7, the heaters 15 to 20 of the respective sub-sections of the placing section are connected via a series circuit of a photo triac 34a of SSR 34 and the thermal fuses 27 to 32, for example, to a 100 V commercial power source 36. The control circuit 33 detects temperatures of the shelves 10 to 13 and left and right bottom plates 14a and 14b, based on detection signals from the placing section temperature sensors 21 to 26. The control circuit 33 then compares the detection temperatures with set temperatures of the shelves 10 to 13 and the left and right bottom plates 14a and 14b. The control circuit 33 controls a photo diode 34b of SSR 34 according to the results of comparison thereby to turn the photo triac 34a on and off, whereby the control circuit 33 turns the heaters 15 to 20 on and off.

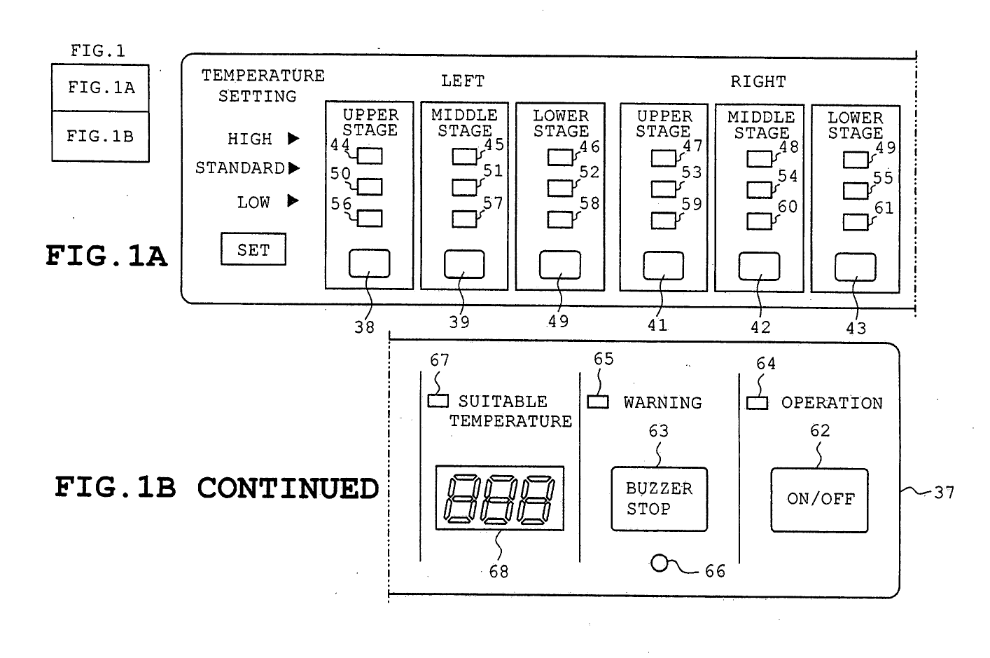

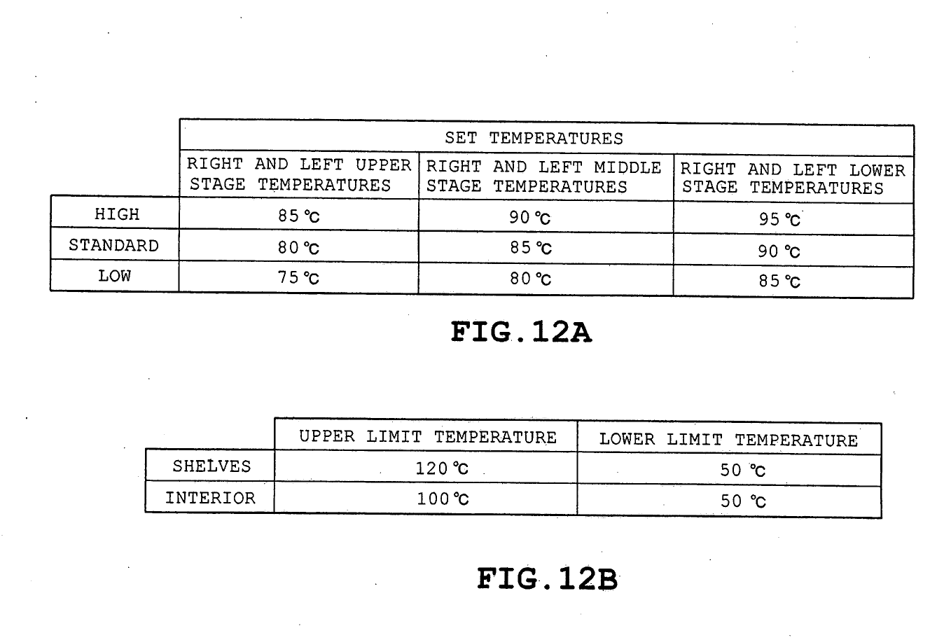

Set temperatures of the sub-sections of the placing section (the shelves 10 to 13 and left and right bottom plates 14a and 14b) are set in modes of “STANDARD,” “HIGH” and “LOW.” FIG. 12A shows the set temperatures of “STANDARD,” “HIGH” and “LOW.” In FIG. 12A, the left lower stage plate refers to the left bottom plate 14a and the right lower stage plate refers to the right bottom plate 14b. The user operates temperature selecting switches 38 to 43 of the operation panel 37 as shown in FIG. 1 in order that one of “STANDARD,” “HIGH” and “LOW” may be set. The operation panel 37 is mounted on the underside of the base 2 (see FIG. 3.). Every time the user operates the temperature selecting switches 38 to 43 once, the set temperatures of the shelves 10 to 13 and bottom plates 14a and 14b are changed sequentially from “STANDARD” to “HIGH” and “LOW” in this order. When the user operates the temperature selecting switches 38 to 43 once again, the set temperature returns to “STANDARD.”

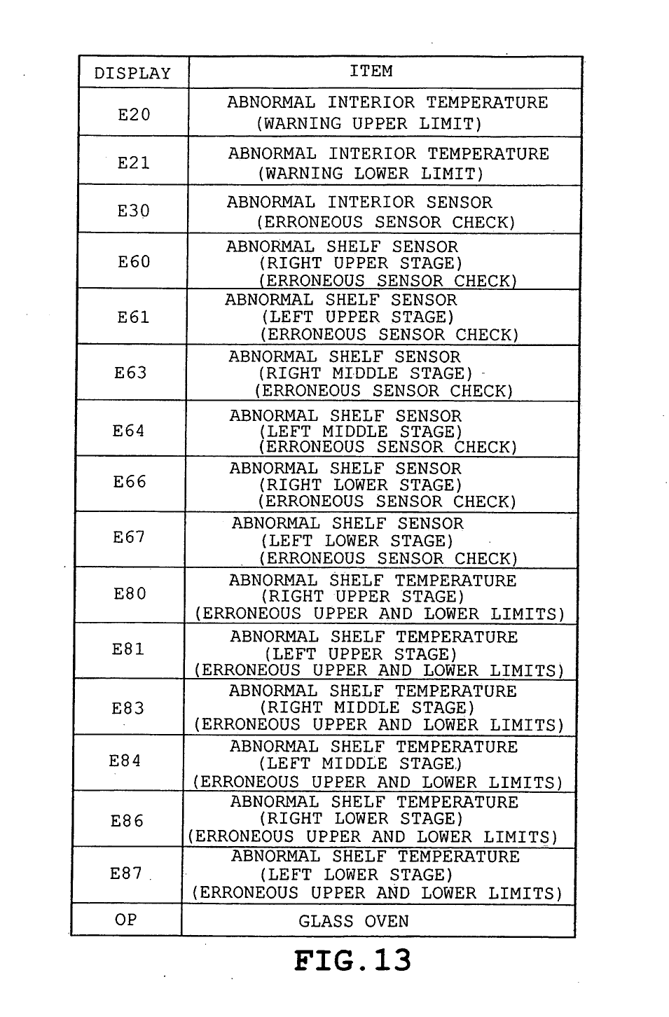

The temperature selecting switches 38 to 43 are mounted on the operation panel 37 as shown in FIG. 1. Over the switches 38 to 43 are mounted “HIGH” temperature setting lamps 44 to 49, “STANDARD” temperature setting lamps 50 to 55 and “LOW” temperature setting lamps 56 to 61 in three rows. The “HIGH” temperature setting lamps 44 to 49 are located highest. The “STANDARD” temperature setting lamps 50 to 55 are located below the “HIGH” temperature setting lamps 44 to 49, and the “LOW” temperature setting lamps 56 to 61 are located below the “STANDARD” temperature setting lamps 50 to 55. When a set temperature is selected by the temperature selecting switches 38 to 43, the lamp indicative of the selected set temperature is turned on. The operation panel 37 further includes a power switch 62, buzzer stop switch 63, operation lamp 64, warning lamp 65, buzzer 66, suitable temperature lamp 67 and error display 68. The error display 68 comprises three 7-segment display sections and displays the contents of failure by a combination code of character “E” and numeral as shown in FIG. 13 as will be described later.

To the control circuit 33 are connected the placing section temperature sensors 21 to 26 and SSR 34 for on-off control of the heaters 15 to 20. To the control circuit 33 are further connected via a drive circuit 69 the temperature setting lamps 44 to 61, operation lamp 64, warning lamp 65, suitable temperature lamp 67 and error display 68. To the control circuit 33 are still further connected the temperature selecting switches 38 to 43, power switch 62, buzzer OFF switch 63, door switch 70 and interior temperature sensor 71. An illumination lamp 72 is connected to the drive circuit 69. The door switch 70 comprises a microswitch, for example. The illumination lamp 72 is provided for lighting in the warming compartment 3 although not shown in FIGS. 2 to 5.

The door switch 70 is provided for detecting the opening and closure of the sliding door 9 and mounted on the base 2, for example. The door switch 70 is on when the sliding door 9 is closed. The door switch 70 is turned off when the sliding door 9 is opened. A support pillar 4b (see FIG. 5) is mounted so as to be located at the horizontal center of the rear of the frame 4. The interior temperature sensor 71 is mounted on an upper: part of the support pillar 4b and detects a temperature in the warming compartment 3. The interior temperature sensor 71 also comprises a thermistor as the temperature sensors 21 to 26 do. The interior temperature sensor 71 has one of two terminals connected to the +Vcc and the other grounded via a resistance 73. A common node of the interior temperature sensor 71 and the resistance 73 is connected to the control circuit 33.

The operation of the food heating warmer 1 will now be described. When the user turns on the power switch 62 so that electric power is supplied to the food heating warmer 1, the illumination lamp 72 is turned on and SSR 34 is turned on so that the heaters 15 to 20 are energized. Heat is applied to the shelves 10 to 13 and left and right bottom plates 14a, and 14b as the result of energization of the heaters 15 to 20. When the temperature in the warming compartment 3 becomes equal to or higher than the predetermined temperature, the condition is detected by the interior temperature sensor 71. The control circuit 33 turns on the suitable temperature lamp 67 to notify that food is ready to be put into the warming compartment 3. The set temperatures of the shelves 10 to 13 and left and right bottom plates 14a and 14b are initially set at “STANDARD.” The user then operates the temperature selecting switches 38 to 43 according to an external temperature, type of food (wrapped food, bottled, etc.), setting the temperatures of the shelves 10 to 13 and bottom plates 14a and 14b.

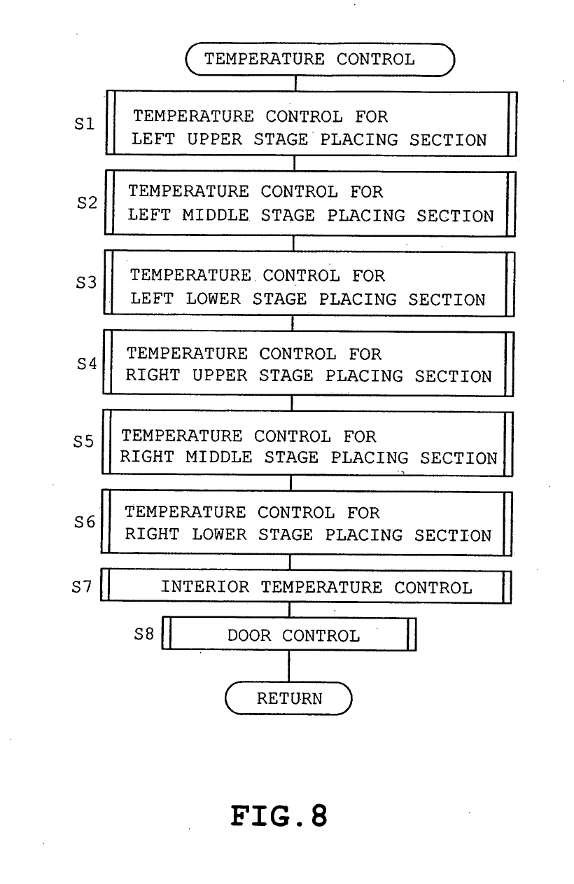

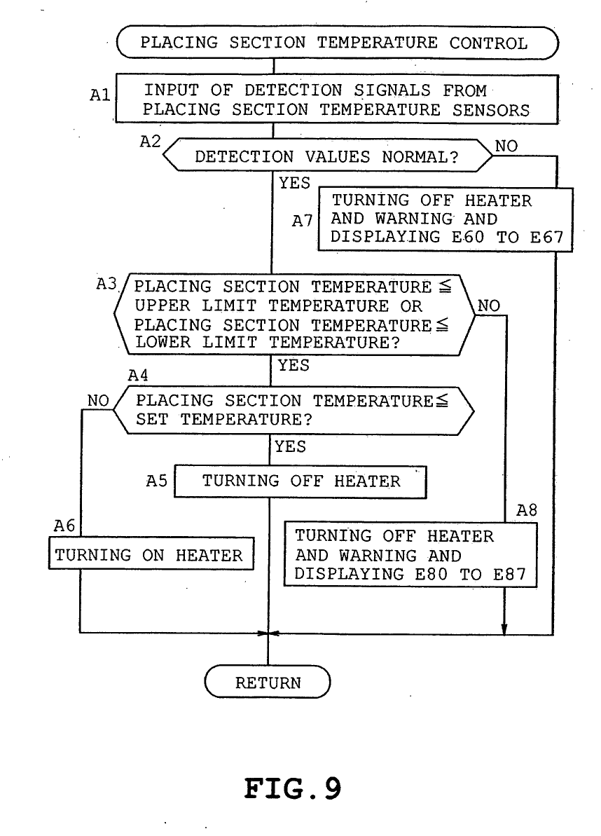

The heaters 15 to 20 are turned on and off according the detection temperatures of the placing section temperature sensors 21 to 26 so that heat is applied to the food and so that the food is maintained at the set temperature. In the embodiment, the control circuit 33 executes a temperature control routine as shown in FIG. 8 every time one second elapses. In the temperature control routine, the control circuit 33 carries out the temperature control for the subdivisions of the placing section (see steps S1 to S6) sequentially and thereafter further carries out an interior temperature control (see step S7) and a door control (see step S8). FIGS. 9 to 11 show the contents of the temperature control for the subdivisions of the placing section, interior temperature control and door control respectively.

In the temperature control routine for the placing section (subdivisions) as shown in FIG. 9, the shelves 10 to 13 and bottom plates 14a and 14b are maintained at the set temperatures, and the user is notified of occurrence of failure upon occurrence of failure, location of failure and type of failure. More specifically, in the temperature control routine as shown in FIG. 8, the control circuit 33 carries the temperature control for the left upper stage placing section or the shelf 10 (step S1) In the temperature control for the shelf 10, as shown in FIG. 9, the control circuit 33 enters a detection signal of the placing section temperature sensor 21 for the shelf 10 (step A1) as shown in FIG. 9. The control circuit 33 then determines the occurrence of failure of the placing section sensor 21 (step A2) and occurrence of failure of the heater 15 of the shelf 10 based on the detection value of the placing section temperature sensor 21 (step A3) as will be described later. When no failure has been detected, the control circuit 33 determines whether the detection temperature of the placing section temperature sensor 21 is not less than the set temperature selected by the temperature selecting switch 38 (step A4).

The set temperature of the shelf 10 is 80° C. when the “STANDARD” has been selected (see FIG. 12A). In this case, when determining that the detection temperature of the placing section temperature sensor 21 is not less than the set temperature (80° C.; and YES at step A4), the control circuit 33 delivers an OFF signal to SSR 34 to turn off the heater 15 (step A5) Furthermore, when determining that the temperature detected by the placing section temperature sensor 21 is less than the set temperature (80° C.; and NO at step A4), the control circuit 33 delivers an ON signal to the SSR thereby to energize the heater 15 (step A6). The shelf 10 is thus maintained at the set temperature as the result of the above-described on-off control of the heater 15. The other shelves 11 to 13 and bottom plates 14a and 14b are controlled in the same manner as described above (see steps S2 to S6 in FIG. 8). In FIG. 8, the left middle stage placing section refers to the left middle stage shelf 12, and the left lower stage placing section refers to the left bottom plate 14a. The right upper stage placing section refers to the right upper stage shelf 11, and the right middle stage placing section refers to the right middle stage shelf plate 13. The right lower stage placing section refers to the right bottom plate 14b.

There is a possibility that the food heating warmer 1 may fail during operation. In the embodiments a first object for detection of failure is the constant temperature heating unit 76 and a second object for detection of failure is the sensor circuit 77. The constant temperature heating unit 76 comprises a sensor circuit 74 and a heater circuit 75. The sensor circuit 74 comprises a series circuit of the placing section temperatures sensors 21 to 26 and the resistance 35, which circuit is connected between the positive power supply +Vcc and the ground. The heater circuit 77 comprises a series circuit of the heaters 15 to 20, SSR 34 and the thermal fuses 27 to 32. The constant temperature heating unit 76 applies heat to the subdivisions of the placing section or the shelves 10 to 13 and bottom plates 14a and 14b so that the respective set temperatures are reached. The constant temperature heating unit 76 maintains the shelves 10 to 13 and bottom plates 14a and 14b at the respective set temperatures. The sensor circuit 77 comprises a series circuit of the interior temperature sensor 71 and the resistance 73, which circuit is connected between the positive power supply +Vcc and the ground.

The failure of the constant temperature heating unit 76 results from “failure of temperature sensor” and “other failure.” In this case, the “failure of temperature sensor” refers to disconnection or short circuit of the sensor circuit 74 and includes disconnection or short circuit of the placing section temperature sensors 21 to 26. The “other failure” refers to disconnection or short circuit of the heater circuit 75 including disconnection or short circuit of the SSR 34 and heaters 15 to 20. The failure of the sensor circuit 74 and the heater circuit 75 is detected by the control circuit 33 in the following manner. When disconnection occurs in the placing section temperature sensors 21 to 26 or sensor circuit 74, the detection signals of the placing section temperature sensors 21 to 26 to be entered into the control circuit 33 differ depending upon a location of the disconnection. In this case, the voltage of the positive power supply +Vcc or ground voltage is supplied into the control circuit 33 depending upon the location of the disconnection.

On the other hand, when the heater circuit 75 is short-circuited or for example, when the photo triac 34a is short-circuited such that the heater circuit 75 remains energized, the heaters 15 to 20 are normally energized and not de-energized, whereupon the temperatures of the heaters 15 to 20 are increased to abnormally high values. On the contrary, when the heater circuit 75 is disconnected, the heaters 15 to 20 are normally de-energized and not energized such that the temperatures of the heaters 15 to 20 are rendered abnormally low. The control circuit 33 then executes a temperature control routine for the placing section as shown in FIG. 9, for example, a temperature control routine for the left upper stage shelf 10. The control circuit 33 enters a detection signal of the placing section temperature sensor 21 (step A1) and determines whether the detected value of the placing section temperature sensor 21 is normal, that is, is equal to the voltage of the positive power supply +Vcc or the ground voltage (step A2). When the detected value of the placing section temperature sensor 21 is not equal to the voltage of the positive power supply +Vcc or the ground voltage, the control circuit 33 determines that the detected value of the placing section temperature sensor 21 is normal (YES at step A2), thereby further determining that the sensor circuit 74 is normal without failure.

On the other hand, when the detected value of the placing section temperature sensor 21 is equal to the voltage of the positive power supply +Vcc or the ground voltage, the control circuit 33 determines that the placing section temperature sensor 21 (the sensor circuit 74) has failed (NO at step A2). The control circuit 33 then turns off SSR 34 to de-energize the heater 15 and carries out warning and displaying to notify the user of the failure (step A7). More specifically, the control circuit 33 controls all the three-staged temperature setting lamps 44, 50 and 56 corresponding to the shelf 10 so that these lamps flash. The control circuit 33 also turns off the suitable temperature lamp 67 and turns on the warning lamp 65. The control circuit 33 further activates the buzzer 66 and controls the error display 68 so that the contents of error are displayed. In this case, display of the error contents by the error display 68 is carried out by any one of code designations E60, E61, E63, E64, E66 and E67. The code designation of E61 is displayed since the placing section temperature sensor 21 of the left upper stage shelf 10 has failed.

When determining that the sensor circuit 74 has not failed (YES at step A2), the control circuit 33 starts detection of failure in the sensor circuit 74, determining whether the temperature of each sub-section of the placing section is not more than an upper limit temperature or not less than a lower limit temperature (step A3). FIG. 12B shows determined upper and lower limit temperatures of each sub-section of the placing section. When the detection temperature of the placing section temperature sensor 21 is not more than the upper limit temperature (120° C.) or not less that the lower limit temperature (50° C.), the control circuit 33 determines that the heater circuit 75 has no failure (YES at step A3), advancing to the temperature control in which the heater 15 is energized or de-energized according to the detection temperature of the placing section temperature sensor 21 (see above-described steps A4 to A6).

When the temperature detected by the placing section temperature sensor 21 is above the upper limit temperature or below the lower limit temperature, the control circuit 33 determines that the heater circuit 75 has failed (NO at step A3) The control circuit 33 then turns off SSR 34 to de-energize the heater 15 and carries out warning and displaying to notify the user of the failure (step A8). More specifically, the control circuit 33 controls all the three-staged temperature setting lamps 44, 50 and 56 corresponding to the shelf 10 so that these lamps flash. The control circuit 33 also turns off the suitable temperature lamp 67 and turns on the warning lamp 65. The control circuit 33 further activates the buzzer 66 and controls the error display 68 so that the contents of error are displayed. In this case, display of the error contents by the error display 68 is carried out by code designations E81 as shown in FIG. 13.

The above-described error detection in the sensor circuit 74 and the heater circuit 75 is carried out in the same manner for the subdivisions other than the shelf 10. When an error is detected, warning and displaying are carried out in the same manner as in step A7 or A8. A code designation corresponding to the last detected error is displayed on the error display 68.

The buzzer 66 is activated when the sensor circuit 74 or the heater circuit 75 has failed. Accordingly, the user quickly finds occurrence of failure. The buzzer 66 is de-activated when the user operates the buzzer OFF switch 63. When finding the failure, the user recognizes the failed placing by the flashing temperature setting lamps 44, 50 and 56. For example, when the temperature setting lamps 44, 50 and 56 flash, the user recognizes that the constant temperature heating unit 76 of the left upper stage shelf 10 has failed. Furthermore, when viewing a code displayed on the error display 68, the user can find which one of the sensor circuit 74 including the placing temperature sensors 21 to 26 and the heater circuit 75 has failed. Consequently, the user can easily find a location and cause of the failure, whereupon repair can quickly be carried out.

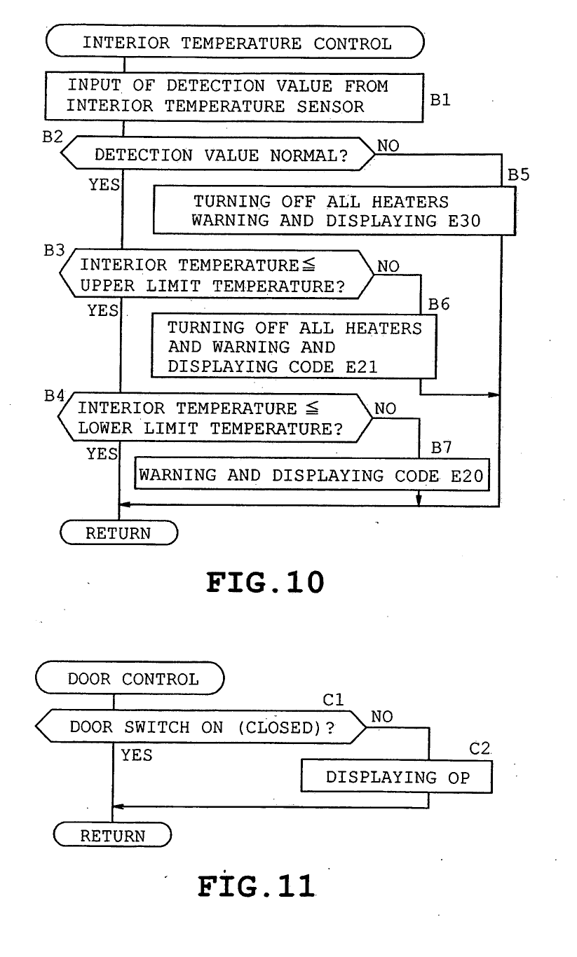

When finishing the temperature control for the placing section (see steps S1 to S6) in the temperature control routine as shown in FIG. 8, the control circuit 33 advances to an interior temperature control (step S7). The detection of a failure in the sensor circuit 77 of the interior temperature sensor 71 is carried out in the interior temperature control. More specifically, as shown in FIG. 10, the control circuit 33 firstly enters a detection signal of the interior temperature sensor 71 (step B1) in the interior temperature control. The control circuit 33 then determines whether a detection value of the interior temperature sensor 71 is normal (step B2). The interior temperature sensor 71 configures the sensor circuit 77 in the same manner as the placing section temperature sensors 21 to 26. Accordingly, the voltage at the positive power supply +Vcc or ground potential is delivered to the control circuit 33 upon occurrence of a short circuit or disconnection. When the detection value of the interior temperature sensor 71 is not equal to the voltage at the positive power supply +Vcc or ground potential, the control circuit 33 then determines that the sensor circuit 77 has no failure (YES at step B2).

When the sensor circuit 77 has no failure, the control circuit 33 determines whether a detection temperature of the interior temperature sensor 71 is equal to or below the upper limit temperature (step B3) and whether the detection temperature of the interior temperature sensor 71 is equal to or above the lower limit temperature (step B4). When the detection temperature of the interior temperature sensor 71 is equal to or below the upper limit temperature (YES at step B3) and equal to or above the lower limit temperature (YES at step B4), the control circuit 33 determines that sensor circuit 77 has no failure, finishing the interior temperature control routine.

When the sensor circuit 77 including the interior temperature sensor 71 has failed, the detection value of the interior temperature sensor 71 is equal to the voltage at the positive power supply +Vcc or ground potential. In this case, the control circuit 33 determines that the sensor circuit 77 has failed (NO at step B2). The control circuit 33 then advances to step B5 to deliver OFF signals to the SSRs 34 of all the heaters 15 to 20 to de-energize all the heaters 15 to 20. Furthermore, the control circuit 33 turns off the suitable temperature lamp 67 and activates the buzzer 66. The control circuit 33 further causes the error display 68 to display a code “E30” (see FIG. 13) indicative of failure of the interior temperature sensor 71.

Furthermore, when the detection temperature of the interior temperature sensor 71 is above the upper limit value (NO at step B3), the control circuit 33 advances to step B6 to de-energize all the heaters 15 to 20 in the same manner as in the aforementioned step B5. The control circuit 33 also turns off the suitable temperature lamp 67 and activates the buzzer 66. The control circuit 33 further causes the error display 68 to display a code “E20” (see FIG. 13) indicative of abnormal temperature in the warming compartment 3 (upper limit warning). Still furthermore, when the detection temperature of the interior temperature sensor 71 is below the lower limit value (NO at step B4), the control circuit 33 carries out warning and notifying (step B7). In the warning and notifying, the control circuit 33 turns off the suitable temperature lamp 67 and activates the buzzer 66. The control circuit 33 further causes the error display 68 to display a code “E21” (see FIG. 13) indicative of abnormal temperature in the warming compartment 3 (lower limit warning). A major cause for the drop of the temperature in the warming compartment 3 below the lower limit temperature is the sliding doors 8 or sliding door 9 which is left open such that an external air is introduced through the opening into the warming compartment 3.

Accordingly, when the temperature in the warming compartment 3 is below the lower limit temperature (NO at step B4), the control circuit 33 continues a heating warming operation without the de-energizing of the heaters 15 to 20. In this case, when the user finds the sliding doors 8 or the sliding door 9 left open as the result of activation of the buzzer 66, closing the sliding doors 8 or sliding door 9, the temperature in the warming compartment 3 rises to or above the lower limit temperature. The control circuit 33 turns on the suitable temperature lamp and stops the buzzer 66 when the interior temperature sensor 71 has detected the interior temperature equal to or higher than the lower limit temperature (YES at step B4). In this case, the user often operates the buzzer OFF switch 63 to stop the buzzer 66. Additionally, the control circuit 33 stops the code display by the error display 68.

Thus, when the sensor circuit 77 fails or when the temperature in the warming compartment 3 is abnormally high or low, warning is carried out and the contents of failure are displayed on the error display 68 in the interior temperature control routine. Consequently, the user can easily find out the cause for the failure, whereupon the failure can quickly be coped with. The cause for abnormal high temperature in the warming compartment is considered to be a short circuit in any one of the heater circuits 75 corresponding to the respective heaters 15 to 20. Furthermore, the cause for abnormal low temperature in the warming compartment is considered to be the sliding door 9 left open.

Upon completion of the interior temperature control routine, the control circuit 33 advances to a door control routine (see step S8 in FIG. 8). In the door control routine, as shown in FIG. 11, the control circuit 33 determines whether the door switch 70 is turned on or whether the sliding door 9 is closed (step C1). The door switch 70 is in an on-state when the sliding door 9 is closed. Accordingly, the control circuit 33 determines in the affirmative at step C1, finishing the door control routine. On the other hand, when the door switch 70 is turned off, the control circuit 33 determines in the negative at step Cl,, displaying “OP” on the error display 68. When viewing the “OP,” the user finds that the sliding door 9 is left open, closing the sliding door 9.

In the foregoing embodiment, when any one of the constant temperature heating units 76 of the placing (the shelves 10 to 13 and the left and right bottom plates 14a and 14b) fails, the control circuit 33 notifies the failed constant temperature heating unit 76. In this case, among the lamps 44-49, 50-55 and 56-61 indicative of “HIGH,” “STANDARD,” and “LOW” respectively, one corresponding to the failed sub-section of the placing is caused to flash, whereby the control circuit 33 informs the user which one of the constant temperature heating units 76 of the sub-sections of the placing has failed. These lamps 44-49, 50-55 and 56-61 indicative of “HIGH,” “STANDARD,” and “LOW” respectively are mounted on the operation panel so as to be located over the temperature selecting switches 38 to 43 which are operated so that the temperatures of the respective subdivisions of the placing are set. Consequently, the user can recognize which one of the constant temperature heating units 76 of the sub-sections of the placing has failed.

Moreover, the control circuit 33 causes the error display 68 to display the failure location in the constant temperature, heating unit 76. Consequently, the user finds which one has failed between the sensor circuit 74 side including the placing section temperature sensors 21 to 26 and the heater circuit 75 side including the heaters 15 to 20. Consequently, the user can easily specify the location of and cause for the failure when repair is carried out, whereupon the failure can quickly be coped with. Additionally, upon occurrence of a failure, the control circuit 33 determines which one of the sensor circuit 74 side and the heater circuit 75 side, based on the detection values of the placing section temperature sensors 21 to 26. Consequently, an arrangement for determining the failed circuit can be simplified.

Furthermore, when determining occurrence of failure based on the detection values of the placing section temperature sensors 21 to 26, the control circuit 33 de-energizes only the heater of the placing sub-section determined to have failed while the other heaters are continuously energized. Consequently, the heating warming operation of the food heating warmer 1 can be continued. When the heating warming operation is continued with one of the placing section sub-sections having failed, a first problem to be expected is that the temperature of the placing rises to an abnormally high temperature. The abnormally high, temperature of the placing results from, for examples failure of SSR 34 of the heater circuit 75 of the placing section sub-section. In this case, the heater is continuously energized 5 even when the control circuit 33 delivers an OFF signal to SSR 34. In the embodiment, the thermal fuses 27 to 32 are provided in the placing section sub-sections respectively. Accordingly, even when the control circuit 33 cannot de-energize the heaters 15 to 20, the thermal fuse melts down thereby to de-energize one 10 of the heaters 15 to 20 when the temperature of the placing section is increased to a predetermined value. Accordingly, the problem that the temperature of the placing rises to an abnormally high value can be overcome, whereupon safety of the food heating warmer can be improved. The temperature in the warming compartment 3 15 exceeds the upper limit temperature even if the thermal fuse does riot melt down or the heater cannot be cut off though the thermal fuse melts down. In this case, the interior temperature sensor 71 detects the high-temperature state. Based on the detection by the sensor 71, the control circuit 33 activates the buzzer 66 and causes the error display 68 to display an indication that the interior temperature has exceeded the upper limit temperature. In response to the activation of buzzer 66 and the display, the user can turn off the power switch 62, whereupon the temperature of the placing can be prevented from being 25 abnormally increased. Consequently, the safety of the food heating warmer 1 can further be improved.

When the heating warming operation is continued with one of the placing section sub-sections having failed, a second problem to be expected is that the temperature of food placed on the failed placing section sub-section drops. The failed placing section sub-section has a difficulty in maintaining the set temperature. However, since the interior of the warming compartment 3 is maintained at a suitable temperature by the heaters of the other placing section sub-sections, the food placed on the failed placing section subdivision can be maintained at a suitable temperature. When the temperature in the warming compartment 3 drops below the lower limit temperature, the interior temperature sensor 71 detects the low-temperature state. Based on the detection of the low-temperature state, the control circuit 33 activates the buzzer 66 and causes the error display 68 to display an indication that the interior temperature is below the lower limit temperature. In response to the activation of buzzer 66 and the display, the user can turn off the power switch 62 to stop the operation of the food heating warmer 1, whereupon the selling of the food is interrupted. Consequently, the food which is not heated to a suitable temperature can be prevented from being distributed.

Additionally, in the foregoing embodiment, the temperature of the placing part can be set at “HIGH” and “LOW” other than “STANDARD.” Consequently, the set temperature of the placing section sub-section can be changed according to a type of food to be placed on the placing part or external temperature, whereupon the food can be heated to and maintained at a suitable temperature.

### Second Embodiment

A second embodiment of the invention will be described. In the second embodiment, the control circuit 33 disallows the heaters 15 to 20 to be energized when the door switch 70 is off or the closed state of the sliding door 9 (the state as shown in FIG. 5) has not been detected. More specifically, the control circuit 33 energizes the heaters 15 to 20 only when the door switch 70 is off. Furthermore, when the door switch 70 is off, the control circuit 33 turns off the in-operation lamp 64 as well as disallows the heaters 15 to 20 to be energized.

When the sliding door 9 is opened by the user (a cleaning man or woman) for the purpose of cleaning the interior of the warming compartment 3, the control circuit 33 stops energization of the heaters 15 to 20 whose temperatures are high even when the power switch 62 is on. Accordingly, the user can be prevented from erroneously touching the heaters 15 to 20 whose temperatures are high by energization or the placing section sub-section heated by the heaters 15 to 20. Furthermore, when the door switch 70 is in the off state, the control circuit 33 disallows the heaters 15 to 20 to be energized and turns off the in-operation lamp 64. Accordingly, when the sliding door 9 is closed incompletely, the operation lamp 64 is turned off although the power switch 62 is turned on. The user confirms the state, thereby recognizing the sliding door 9 is incompletely closed. Consequently, the user can re-close the sliding door 9 and there is no possibility that the heating warming operation is continued while hot air leaks from a gap between the frame 4 and the sliding door 9.

### Other Embodiments

The invention should not be limited to the foregoing embodiments. The embodiments may be modified as follows. The switching element should not be limited to SSR 34 but may be a single triac or an insulated gate bipolar transistor (IGBT) or the like, instead. The power switch 62 may comprise an electric or electronic component (for example, SSR) which can be controlled by the control circuit 33. In this case, the control circuit 33 may turn off the power switch thereby to de-energize all the heaters 15 to 20 at steps B5 and B6. The food heating warmer may be provided with a hot air circulating apparatus comprising a hot air heater and a fan motor and supplying hot air into the warming compartment 3. In this case, in the second embodiment, the control circuit 33 may de-energize the hot air heater as well as the heaters 15 to 20 when the sliding door 9 is open (the door switch 70 is off).

The food heating warmer may be provided with a steam generator comprising a steam heater and an evaporating pan and supplying steam into the warming compartment 3 for humidification. In this case, in the second embodiment, the control circuit 33 may de-energize the steam heater as well as the heaters 15 to 20 when the sliding door 9 is open (the door switch 70 is off). Furthermore, the sliding door 9 may be slidable back and forth, instead of vertically. In this construction, when the sliding door 9 is slid frontward so as to be opened, a space is defined between the sliding door 9 and the frame 4 at each side of the food heating warmer 1. The user can put his or her hand through the space into the warming compartment 3. Consequently, the inner surface of the sliding door 9 and the interior of the warming compartment 3 can readily be cleaned.

When the sliding door 9 is mounted so as to be slidable back and forth, for example, a sliding rail may be provided and comprises an outer member fixed to the base 2 side and an inner member which is fixed to the sliding door 9 side and is slidable back and forth relative to the outer member. Furthermore, the sliding rail may be provided with a stopper which prevents the sliding 9 from being drawn forward more than a predetermined length. Furthermore, the sliding door 9 may be provided with a supporting member to which the inner member of the sliding rail may be fixed. In this case, the door switch 70 may be located so that a switch portion of the door switch 70 is pressed by the supporting member into the ON state.

A pillar may be provided on the base 2 and the outer member of the sliding rail may be fixed via the pillar to the base 2 side. The sliding rail may comprise a guiding member provided at the base 2 side and protruding toward the inside of the warming compartment 3 and a guided member provided at the sliding door 9 side so as to be paired with the guiding member. Additionally, two sliding rails may be provided below the sliding door 9 and two sliding rails may be provided over the sliding door 9. Consequently, the opening and closing operations of the sliding door can be stabilized and the airtightness of the warming compartment 3 can be improved in the case where the sliding door 9 is closed.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

What is claimed is:

1. A food heating warmer comprising:
a warming compartment;
a placing section divided into a plurality of sub-sections in the warming compartment so that food is placed on the placing section;
a plurality of constant temperature heating units which are provided so as to correspond to the sub-sections of the placing section, each unit including a heater for heating the sub-section, a sub-section temperature sensor detecting a temperature in each sub-section, and a switching element turning the heater on and off according to the temperature detected by the sub-section temperature sensor;
a failure detecting unit which detects failures of the constant temperature heating units provided for the respective sub-sections of the placing section; and
a notifying unit which specifies and notifies the constant temperature heating unit for which failure has been detected by the failure detecting unit.

2. The food heating warmer according to claim 1, wherein the failure detecting unit is capable of detecting contents of the failures of the constant temperature heating units by dividing the contents into failures of the divided section temperature sensors and other failures, based on input values of the divided section temperature sensors, and the notifying unit specifies and notifies the constant temperature heating unit for which the failure has been detected by the failure detecting unit and notifies contents of the failure of the constant temperature heating unit detected by the failure detecting unit.

3. The food heating warmer according to claim 1, further comprising a heating stop unit which stops energization of the heater of the constant temperature heating unit for which the failure has been detected, when the failure of the constant temperature heating unit has been detected.

4. The food heating warmer according to claim 1, further comprising an interior temperature, sensor which: detects a temperature in the warming compartment and a heating and warming operation stop unit which stops energization of the heaters of all the constant temperature heating units, wherein the heating and warming operation stop unit stops energization of the heaters of all the constant temperature heating units when the temperature detected by the interior temperature sensor has exceeded a predetermined upper limit temperature, and the notifying unit notifies a failure of the constant temperature heating unit when the temperature detected by the interior temperature sensor has exceeded the predetermined upper limit temperature.

5. The food heating warmer according to claim 1, further comprising an interior temperature sensor detecting a temperature in the warming compartment, wherein the notifying unit warns when the temperature detected by the interior temperature sensor is lower than a predetermined lower limit temperature and stops warning when the temperature detected by the interior temperature sensor is equal to or higher than the predetermined lower limit temperature after the warning.
